(19) United States
(12) Patent Application Publication
(10) Pub. No.: US 2006/0122767 A1
(43) Pub. Date: Jun. 8, 2006

(54) Map based estimations, and information search

(76) Inventor: Ravi G.A. Athalye, St Cloud, MN (US)

Correspondence Address: Ravi G. Athalye, 44882 Revere Drive, Novi, MI, 48377, US

(21) Appl. No.: 11/006,377

(22) Filed: Dec. 7, 2004

(51) Int. Cl. G01C 21/00

(52) U.S. Cl. 701/200; 340/995.1

(57) ABSTRACT

Typically a family relocating to a new place is faced in making a number of decisions with respect to identifying a location to live. Identification of such a location, is dependent on the distances from places of work and the amenities available at the various locations that fit the distances criteria. During the process of identification there is a need to generate the routes between the locations for a quick assessment of the commuting involved between the locations and even generate the driving instructions between the locations so marked on the map. Current software maps and related software do not have an easy way to identify the regions on the map that meet the distance criteria and then to connect the address on the map to specific information. The current invention creates an easy way to use a map to, estimate distances of the various towns/cities around the target locations. generate routes connecting locations and directions without having to know the zip codes to the locations visually marked on the map and generate driving directions associated with the routes. research amenities availability around the target location. create report consolidating the information pertinent to the user needs. Using a map that can be marked enables an easy graphical method of identifying areas that meet the distance criteria, the connecting routes and obtain information associated with the areas pertinent to the user requirements.

### FIELD OF THE INVENTION

A family trying to relocate to another city or town is faced with making many decisions, amongst them, identifying neighborhoods located centrally to places of work and schools. It then becomes necessary to identify neighborhoods that fall within the commuting distance and having amenities that are specific to the needs of the family. The routes between locations are also researched for the ease of commuting. Zeroing down to a single location is a matter of optimizing distances/amenities/connecting routes and affordability.

The current invention is an information search system that utilizes a map to be the starting point to a relocation process. It does not require knowledge of zip codes by the user. It is a convenient method to visually scan the map for the criteria mentioned requiring minimum input from keyboard. It is intended to be a quick first scan in the decision process.

The relocation process requirements in general are:
Neighborhoods that meet the distance criteria from places of work.
A scan of the route between locations.
Availability of amenities.
Affordability of the places that meet the above criteria.

The current invention enables the user an easy way to get answers to the above queries from a map that is created with embedded geographic co ordinates. The geographic co ordinates being either zip codes, longitude and latitude or GPS , UTM co ordinates.

The invention introduces:
a feature of progressive distance scan of regions and locations around a location of interest.
a scan of the route or routes between two or multiple locations on the map by pointing and marking the locations on the map.
an ability to generate a list of location co ordinates that meet the distances criteria.
an ability to create queries associated with the list.
an ability to get the information associated with the queries and create a report.
an ability to create a route or routes connecting locations graphically marked on the map and being able to generate driving directions for the route so graphically marked without the user requiring to know the zip codes.

### BACKGROUND OF THE INVENTION

1. Field of Invention

The invention generally relates to system for identifying locations that meet user specific distance criteria between multiple locations and obtaining information about the locations using markings on the map as inputs and as a consequence keeping the use of keyboard to a minimum. The invention also provides a ‘point and search’ tool that enables generating commuting routes between locations that meet a user defined criteria without having the user to know the zip codes of the locations. The system is intuitive and provides a quick, easy tool to connect with information regarding the locations.

2. Description of Prior Art

Mapping softwares allow a user to read maps and estimate distances using a static linear scale. The scale has limited functionality. The scale cannot be moved on the map or project circular scale, around locations to estimate in general distances of neighborhoods from the locations. Routes between locations are generated by keying in zip codes of locations or the addresses of the two locations. In the initial stages of identifying routes there is no tool by which routes between locations can be generated without knowing the zip codes or addresses of locations. With the 20^{th} century mobile workforce, decisions to relocate are frequent. The software available today though can provide driving instructions and distances between locations, the maps are inconvenient for a family trying to identify location that are optimally located from multiple addresses of work and schools. They require a good eye for estimate of distances and the knowledge of zip codes to get a route map and driving directions. The current invention presents a solution that is intuitive and requires minimum key inputs from a key board and more importantly does not require knowledge of zip codes of the locations on the map.

### SUMMARY OF THE INVENTION

The invention builds on the Operating System and command structure that exist in computers both PCs and Large Computers that are web enabled. The invention is applicable to maps with geographic co ordinates embedded in the map. The functionalities assumed in the invention are well within the capabilities of the PCs and are being used widely today. The creation of the new functionalities described below lie within the capabilities of a software developers trained in the software of choice.

In general it is an object of the present invention to provide a novel and improved method of visualization of a map to assess the distances between locations, routes between locations and be able to capture the location specific co ordinates (which in the preferred embodiment is zip codes) into an information retrieval system, being a spreadsheet in the present embodiment and insert specific queries with respect to the zip codes in the spreadsheet and to obtain information specific to the queries in the spreadsheet.

It is an object of this invention to provide a system which provides a visual tool in the form of a mobile circular scale that enables accurate visualization of distances around locations of interest.

It is another object of this invention to be able to generate multiple scales whose centers can be placed on multiple location of interests.

It is another object of the invention to be able to ‘fill’ enclosures with colored background thereby marking areas of interest.

It is another object of the invention to be able to capture all the location embedded co ordinates data that are marked and enter them into a spreadsheet linked to a database or databases.

It is another object of the invention to be able to enter a menu of queries that are selectable by the user into the spreadsheet and to associate them with the location co ordinates entered therein.

It is another object of the inventions to connect the spreadsheet to a database or data bases and provide information to the queries in the spreadsheet.

It is another object of the invention to generate routes display between locations by marking locations on the map without knowing the zip codes of the locations.

It is another object of the invention to enable the user to limit the number of routes between locations to user-defined criteria within the capabilities of the system.

It is another object of the invention to be able to print the result in a customizable format.

### BRIEF DESCRIPTION OF DRAWINGS.

In general in the preferred embodiment described below, an information retrieval system has been shown as spreadsheet and database. A selection tool has been shown to be a mouse.

FIG. 1 is a picture of a map with a standard scale. 1 shows the standard linear scale conventional maps have. It provides the conversion factor for distance on the map to the distance on ground.

FIG. 2 describes the conversion of the static linear scale to a mobile circular scale. Referring to the figure, by clicking the mouse on end 2 followed by 3 on the linear scale opens up a query asking for miles. By entering the scale maximum distance units, number 40 in the present example, a Circular Scale of radius equaling 40 units is created with divisions converted to Concentric Circles. The zero of the Linear Scale becomes the center of the Circular Scale and the 40 of the Linear Scale becomes a circular division of the Circular Scale. The maximum distance measurable on the Circular Scale becomes large enough to cover the furthest point on the map from the center of the Circular Scale with progressively increasing concentric circles providing labeled distance markings.

FIG. 3 is a picture of a map with a mobile circular scale created with divisions taking the form of concentric circles representing divisions on the linear scale on the map. The concentric circles are marked to distance units providing a visual distance scan of the regions surrounding the target location, on which the center of the circular scale is positioned. In FIG. 3, numbers 7, 8 shows the two ends of the Linear Scale that were used to create the Circular Scale. In this figure the Circular Scale center has been affixed at a particular point 10 on the map. 11 shows that the maximum division on the Circular Scale is determined by the furthest point on the map from the center of the circle. Essentially the Circular Scale maximum radius is free floating and the software generates radius long enough to cover the entire region of the map. The final radius is fixed once the location of the center of the Circular Scale is positioned.

FIG. 4 is a picture of two regions that are being reviewed for the distance criteria. Intersecting area identifies the area that most likely meets the distance criteria from the two locations.

13 shows the center of one circular scale affixed to a location of interest.

14 is the maximum scale reading of circular scale 1.

15 shows the center of the second circular scale affixed to a location of interest.

16 is the maximum scale reading of circular scale 2.

17 is the intermediate conversion process from the linear scale shown on the map.

Once the circular scale is created 17 becomes invisible.

FIG. 5 is a picture of a map with intersecting regions highlighted with a ‘fill’ function.

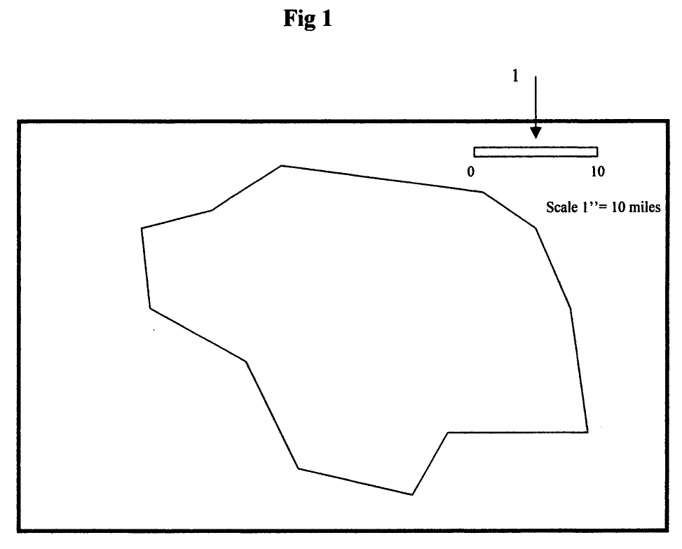

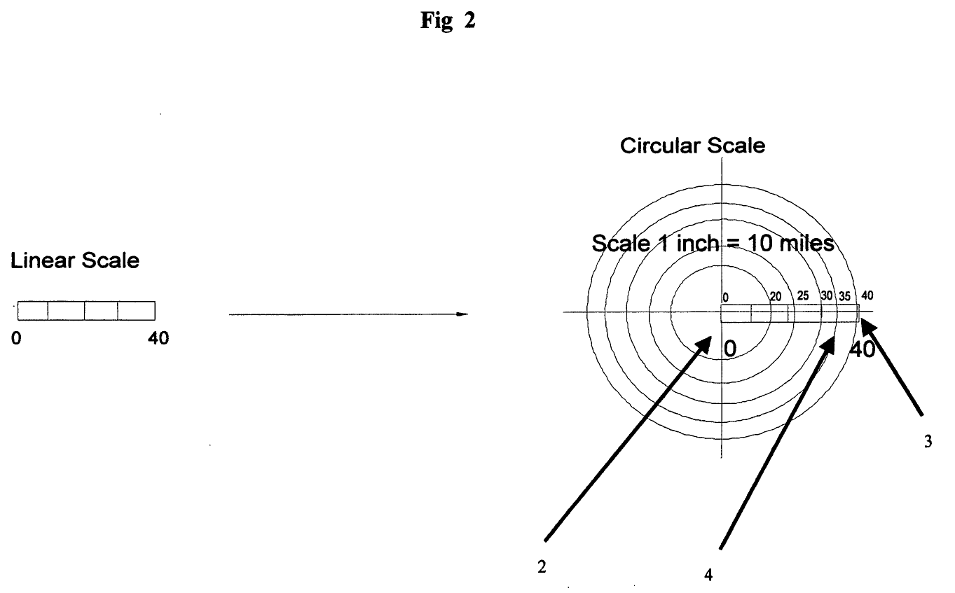

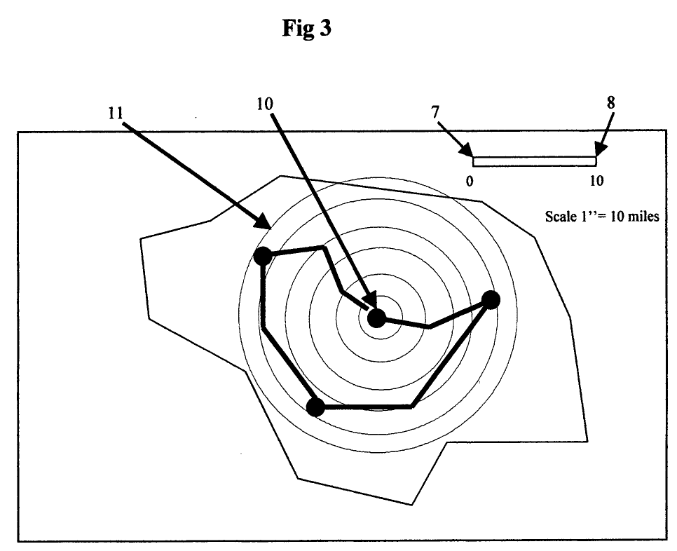

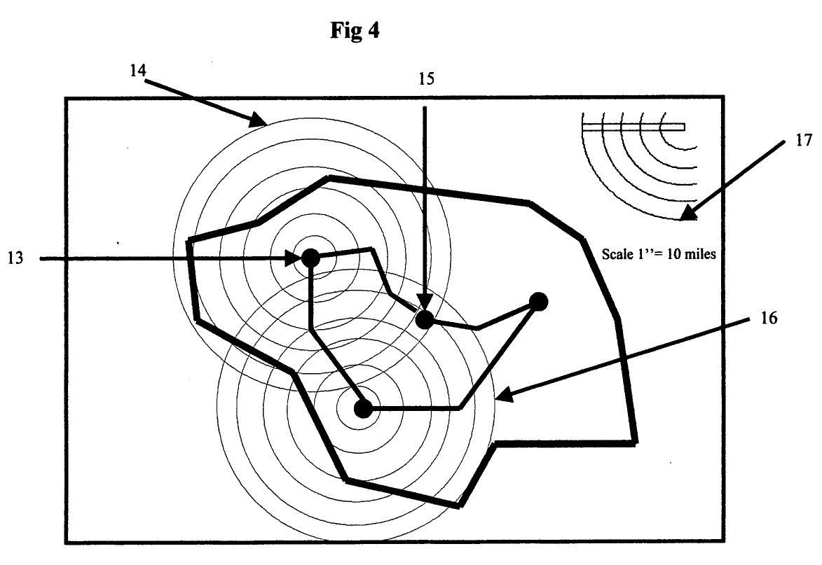

20 shows the first intersection point of the first circular scale with the second circular scale. (Example shown identifies region that is 25 miles from the two centers of the circle)

21 shows the second intersection point of the first circular scale with the second circular scale.

22 shows the corralled area by the intersection of the scales and the portions highlighted by the fill function.

23 is the menu of attributes that is generated once the fill activity is completed.

Column 24 in the menu shows the selection of attributes by the user.

Once the selection is done a spreadsheet with the selection is generated. (Shown in FIG. 6)

FIG. 6 is a picture of the zip codes that were highlighted on the map entered into a Spreadsheet, the menu specific queries entered into the Spreadsheet and the information from the database entered into the Spreadsheet. Print command can be configured to suit customer preference.

Column 30 in the spreadsheet shows the zip codes data transferred from the Map.

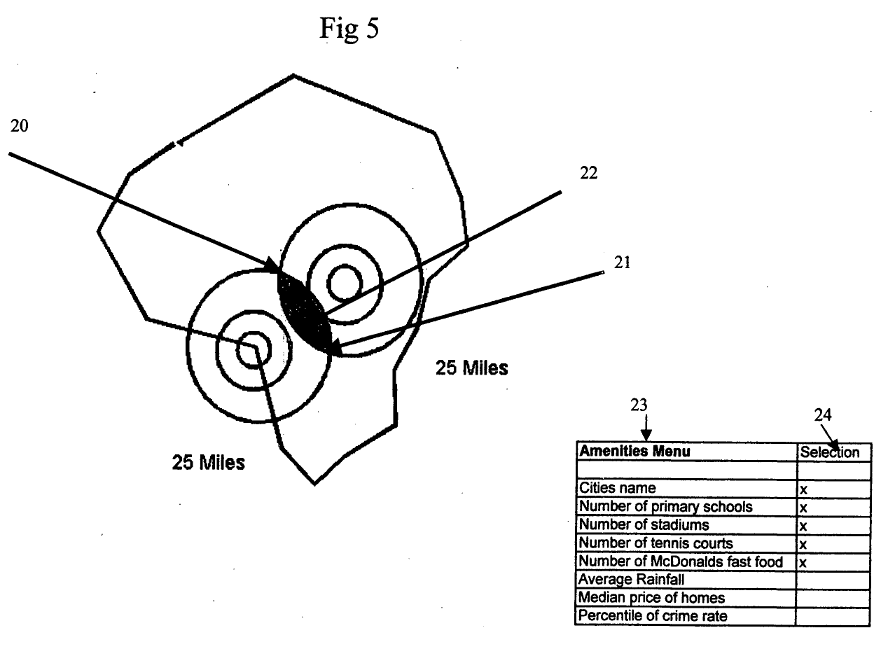

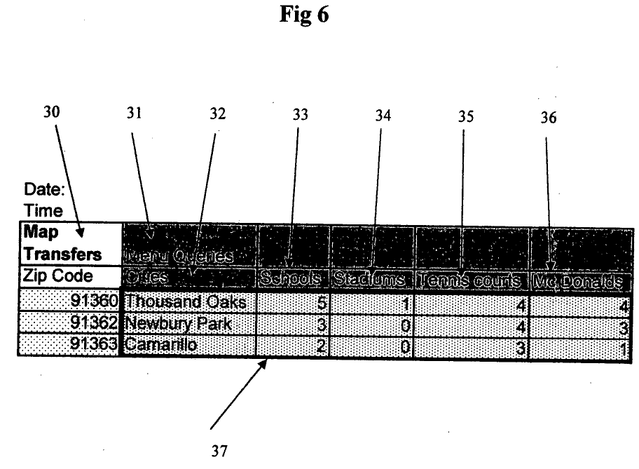

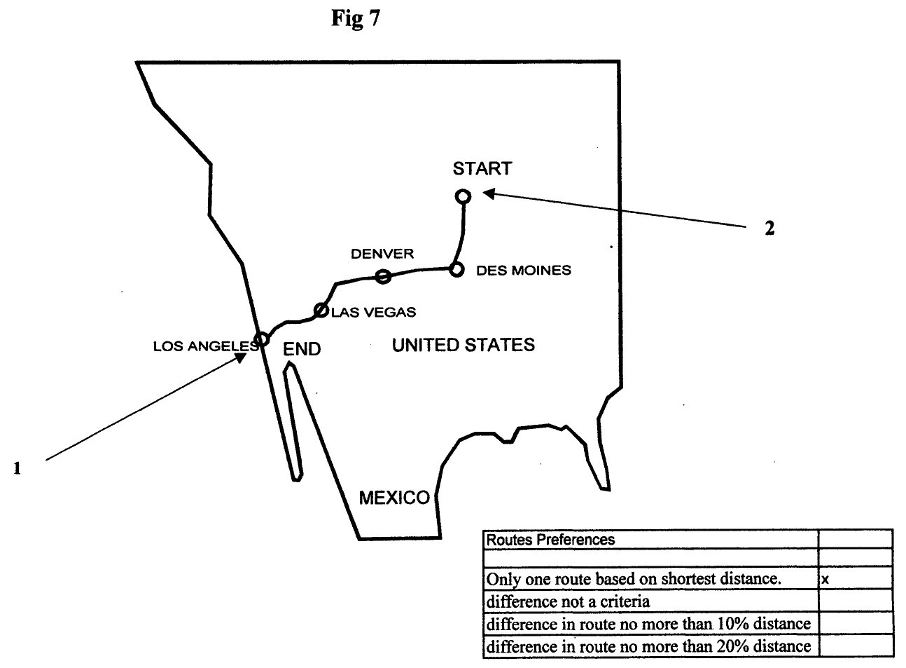

Numbers 31, 32, 33, 34, 35, 36 are the columns that represent the amenities attributes selected from a menu shown from FIG. 5 that the information is sought for.

Region 37 within the bold region of the spreadsheet is the output of the database after the search is completed.

FIG. 7 is a picture of the route created on the map by clicking on the two locations on the map between which the route is desired. In FIG. 7, 1 is the first location that is marked by use of a PC mouse as a selection device so also 2 is the second location, is also marked the same way. This is followed with a set of choices in the form of a menu:
Number of route alternatives
Alternatives criteria: (Menu provided as an example, other choices can be created.)
   Only one route based on shortest distance.
   difference in route no more than 10%
   difference in route no more than 20%
   difference not a criteria.

The example in FIG. 7 shows the route for one route selection with the shortest distance criteria.

### FUNCTIONALITIES OF THE INVENTION

The following are the functions that present novel application to a map with embedded location information:
Creation of circular mobile scales representing the distance on the map to the actual distance.
Ability to make multiple circular scales as required.
Ability to move the scales and affix the centers to the desired locations.
Ability to mark bounded locations by a ‘fill’ function with color of choice.
Ability to transfer the location co ordinates data marked to a spreadsheet as queries.
Ability to further input queries related to the locations marked in the spreadsheet.
Being able to get queries associated information from data bases and inputting the same into the spreadsheet.
Being able to highlight key words from the spreadsheet and input them into a generic search engine to perform a secondary search.
Being able to generate map route between two locations on the map by marking the two locations without having to know the zip codes,
Ability to mark locations on the map and generate route or routes between them based on user defined preferences.
Ability to select the preferences associated with the routes by a selection of choices.

### DETAILED DESCRIPTION

The method described herein is one way of enabling the functions and that there can be other ways to do the same and are within the scope of this patent application.

Function 1: Creation of Circular Scale from a Linear Scale: The circular scale is created by placing the cursor on one end of the linear scale and clicking the mouse and repeating the process on the other end of the linear scale followed by inputting the number of units that represent the distance between the two ends as recorded on the linear scale of the map. This creates the circular scale to match the linear scale except the largest distance represented by the circular scale is sufficient to cover the entire map. The center of the circular scale can be moved and placed at any location on the map. The circular scale with concentric divisions now enables the user to quickly scan the distances of the various locations from any the location placed at the center of the circular scale.

A ‘fill’ function can be used to fill the area/region of interest. Once the concentric scale is created copies of this scale can be created and placed at various other locations of interest. Areas of commonalities between the intersecting scales can be used to identify regions that meet the user defined distance criteria.

It is to be noted that areas can be marked similarly by corralling regions with free hand drawings by using the mouse. The free hand corralling of regions is referred to as ‘Lassoing function’.

Function 2: Existing maps created by software can be magnified or compressed to meet the users requirements. It is an object of the invention to provide suitable logic to merge the location co ordinate or parse them compatible to the magnification of the map. Thus if the magnification of the Map shows a dot as a city then the dot represents a multitude of zip codes which for a particular magnification would represent a single geographic location.

Function 3: Is the ability to mark a location on the map or regions on the map ( fill function) and in so doing obtain the embedded location identification information such as zip codes, or longitude and latitude or other co ordinate system and be able to input the information as data points to queries into a spreadsheet.

Function 4: Is the ability to select from a menu of queries and input them into a spreadsheet corresponding to the geographic location information.

Function 5: Is the ability to search data base or data bases and input the results in the spreadsheet corresponding to the queries.

Function 6: Is the ability to print the output of spreadsheet or parts thereof in a user configurable format.

Function 7: Is the ability to highlight keywords from the spreadsheet and do a web search on the highlighted keywords using generic search engines like Google, Jeeves, Yahoo etc.

Function 8: Is the ability to create reports for information of interest from the spreadsheet.

Function 9: Is the ability to generate route marking on the map, by marking locations on the map, without having to know the zip codes of the locations.

Function 10: Is the ability to impose preferences on the route selection processes by a selection of menu driven choices.

Functions 11: Is the ability to generate driving directions to the route or routes generated on the map without knowing the zip codes based on user preferences.

Function 12: Is the ability to print the information in user defined format.

Each of the task above fall well within the scope of developers trained in information technology to create the functions.

### REFERENCES CITED

Information system for interactive access to geographic information

U.S. Pat. No. 5,945,985 Aug. 31, 1999, Babin 715/500.1

System and method for enterprise-wide business process management

U.S. Pat. No. 6,817,008 Nov. 9, 2004 Ledford 717/100-105, 120-123,705/1,5-9,38 715/513706/45 709/101,246

System for graphically mapping related elements of plurality of transactions.

U.S. Pat. No. 5,963,922 Oct. 5, 1999, Helmering, 705/35;705/1 International Class GO6F 019/00

What is claimed:

1) A method of providing geographic information, comprising:
a) displaying a map, the map having hidden geographic coordinates corresponding to points on the map;
b) enabling a user to select a point on the map;
c) capturing the coordinates of the point selected by the user; and
d) transferring the coordinates into an information-retrieval system to obtain data associated with the coordinates.

2) A method according to claim 1, wherein the method further comprises a step of enabling the user to define an area around the selected point.

3) A method according to claim 2, wherein the step of defining an area comprises selecting a circular area centered on the selected point.

4) A method according to claim 1 wherein the map includes a linear scale and wherein the step enabling the user to position a circular scale having concentric divisions with distance markings corresponding to the divisions of the linear scale and maximum radius dynamically adjusting to the furthest point of the map from the center, as the center is moved on the map and ultimately adopting a fixed value once the center is positioned at a particular point on the map.

5) A method according to claim 3, wherein the map includes a linear distance scale, and wherein the step of enabling the user to select a circular area comprises generating a circular scale having concentric divisions corresponding to divisions on the linear distance scale, positioning the center of the circular scale over the selected point, and highlighting a circular area encircled by a selected one of the divisions of the circular scale.

6) A method according to claim 4 wherein multiple copies of the circular scale are capable of being generated enabling the user to independently position their centers on independent locations.

7) A method according to claim 6 wherein the step of defining an area comprises selecting a section of area bounded by intersecting circular scales.

8) A method according to claim 2, wherein the step of defining an area comprises drawing a freehand boundary around the selected point, and highlighting the area within the freehand boundary.

9) A method according to claim 3, further comprising a step of capturing the coordinates of all points within the selected area.

10) A method according to claim 1, wherein the step of enabling the user to select a point comprises enabling the user to select a first point and a second point, the step of capturing the coordinates comprises capturing the coordinates of both the first point and the second point.

11) A method according to claim 1, wherein the information-retrieval system comprises a database of geographic information.

12) A method according to claim 10, wherein the information-retrieval system comprises a navigation program operative to calculate a route between the first and second points.

13) A method according to claim 1, further comprising the steps of:
a) enabling the user to select a number of queries from a pre-set menu; and
b) displaying data obtained from the information-retrieval system in response to the queries.

14) A method according to claim 13, wherein the data is displayed in the form of a spread sheet.

15) A method according to claim 14, further comprising a step of enabling a user to print all or part of the spread sheet in a user-selected format.

16) A method according to claim 14, further comprising a step of enabling the user to highlight key words from the spread sheet and to input the highlighted words into a generic search engine.

17) A communications interface for use with a geographic search engine, the interface comprising:
a) an electronically generated map having a plurality of hidden embedded coordinates corresponded to points on the map;
b) a selection device for selecting a specific point on the map; and
c) means for capturing the coordinates and inserting the coordinates into an information-retrieval system.

18) The communications interface of claim 17, wherein the selection device is operative to allow the user to draw a free-hand boundary around point and to highlight a region defined by the boundary.

19) The communications interface of claim 17, wherein the map includes a linear distance scale and the selection device is operative to generate a circular scale having a plurality of concentric divisions corresponding to divisions on the linear scale.

20) The communications interface of claim 17, wherein the selection device is operative to center the circular scale over any point on the map, and to highlight a circular area corresponding having a diameter selected by the user.

21) The communications interface of claim 17, wherein the selection device is operative to select a first point and a second point, and wherein the information-retrieval system comprises a navigation program for plotting a route between the points and translating the route into travel instructions.

22) A method of providing geographic information, comprising:
a) displaying a map, the map having linear distance scale;
b) enabling a user to select a point on the map;
c) enabling the user to generate a circular scale having concentric divisions corresponding to divisions on the linear distance scale, position the center of the circular scale over the selected point, and highlight a circular area encircled by a selected one of the divisions of the circular scale.

23) A communications interface for use with a geographic search engine, the interface comprising:
a) an electronically generated map having a linear distance scale; and
b) a selection device for selecting a specific point on the map, wherein the selection device is operative to generate a circular scale having a plurality of concentric divisions corresponding to divisions on the linear scale
